(19) United States
(12) Patent Application Publication
(10) Pub. No.: US 2007/0214801 A1
(43) Pub. Date: Sep. 20, 2007

(54) Thermoelectric frozen dessert system for delivering frozen desserts

(76) Inventor: Betty Ann Baugh, San Francisco, CA (US)

Correspondence Address: BETTY BAUGH;B-810, 555 JOHN MUIR DR., SAN FRANCISCO, CA, 94132, US

(21) Appl. No.: 11/384,072

(22) Filed: Mar. 17, 2006

(51) Int. Cl. F25B 21/02; F17C 13/00

(52) U.S. Cl. 62/3.6; 62/457.9

(57) ABSTRACT

A docking station assembly for serviceable frozen desserts, the docking station assembly comprises a housing for forming an enclosure for the docking station assembly and the housing includes an insert-receiving portion for receiving any of a plurality of removable and replaceable inserts; and a removable and replaceable insert having a docking mating portion which mates with the insert-receiving portion, and having a frozen dessert container mating portion having a shape of a portion of a particular frozen dessert.

### BACKGROUND OF THE INVENTION

1. Field of the Invention

This invention generally relates to serviceable containers delivering frozen desserts for food industries, more particularly, to such docking stations having replaceable inserts for permitting docking of a plurality of frozen dessert.

2. Prior Art

Currently known as a container which includes a base portion into which a frozen dessert is inserted for rendering service for partaking portions. The docking station further includes electrical connector which is connected to conventional refrigerating cooling systems for maintaining frozen desserts.

Although the currently known and utilized docking station is satisfactory, it includes drawbacks. Such prior art only permit refrigerating systems including evaporator, a compressor and a condenser for docking station. Consequently, a user must purchase bulky insulation for an enclosed environment isolating frozen desserts service in each docking station. Obviously, this is not cost efficient.

Consequently, a need exists for a docking station which permits accessible multiple frozen desserts to be inserted therein.

### SUMMARY OF THE INVENTION

The present invention is directed to overcoming one or more of the problems set forth above. Briefly summarized, according to one aspect of the invention, the present invention resides in a docking station assembly for serviceable frozen desserts, the docking station assembly comprising: a) a housing for forming an enclosure for the docking station assembly and said housing includes an insert-receiving portion for enclosed Peltier effect electronic devise receiving any plurality of removable and replaceable inserts; and b) a removable and replaceable insert having a docking mating portion which mates with the insert-receiving portion and having a frozen dessert container shape electronic device.

These and other aspects, objects, features and advantages of the present invention will be more clearly understood and appreciated from a review of the following detailed description of the preferred embodiments and appended claims, and by reference to the accompanying drawings.

### ADVANTAGES EFFECT OF THE INVENTION

The present invention has the advantage of permitting a plurality of frozen desserts to use limited space as docking station.

### BRIEF DESCRIPTION OF THE DRAWINGS

FIG. 1 is a perspective drawing of the present invention;

FIG. 2 is a perspective view of an insert of the present invention that is attached to the docking station of FIG. 1;

FIG. 3 is an orthographic view of a second insert of the present invention that is attachable to the docking station of FIG. 1; and

FIG. 4 is an orthographic view of the insert installed in the docking station.

### DETAILED DESCRIPTION OF THE INVENTION

In the following description, the present invention will be described in the preferred embodiment as the interface comprises a semiconductor or plurality of semiconductors which produce the desired Peltier effect. Those skilled in the art will readily recognize that the equivalent of such software may also be constructed in hardware.

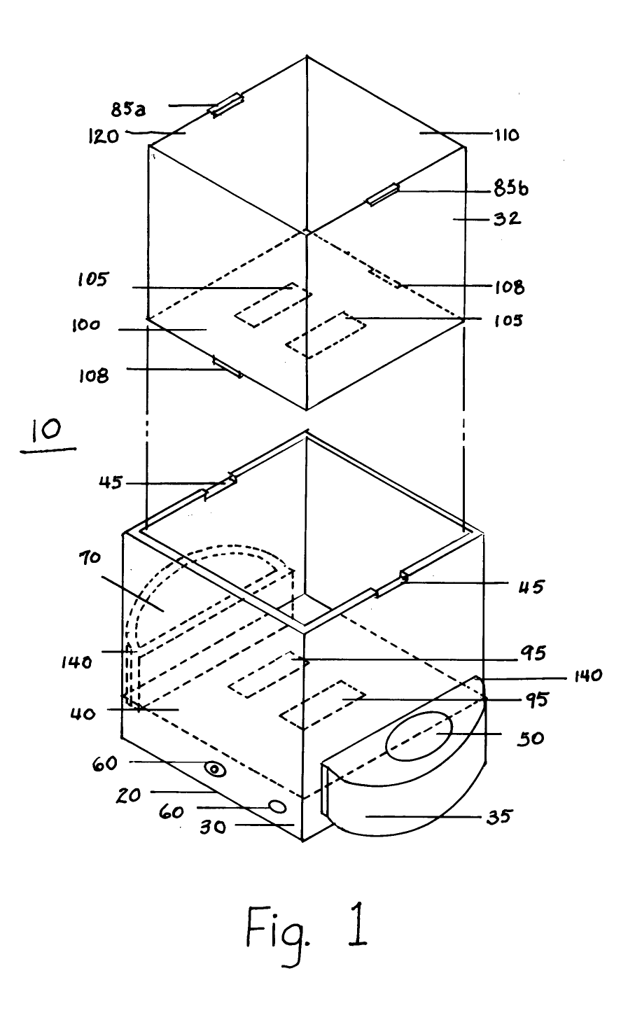

Referring to FIG. 1, there is shown a docking station 10 of the present invention. The docking station 10 includes a base portion 20 for permitting the docking station 10 to be placed on suitable objects, such as buffet tables and the like. The docking station 10 further includes an upper enclosed portion 30 attached to the base 20 which upper portion 30, in combination with the base portion, forms an enclosure for the docking station 10. As is well known to those skilled in the art, the docking station 10 includes electronic components in the interior of the enclosure formed by the base 20 and upper enclosing portion 30 for permitting transmission of thermoelectric cooling system. This transmission may be directed by any suitable Peltier effect system products, such as Technicool™ Product Line, thermo cooling products from Melcor, a unit of Laird Technologies, Trenton, N.J. which products may be installed in thermoelectric coolers.

The upper enclosing portion 30 includes a notched-out, square indentation portion 40 for receiving a receptacle insert 90. It is instructive to note that the indentation portion 40 may receive any of a plurality of inserts, each insert receives a particular frozen dessert. This permits the docking station to be flexible and cost-efficiency in that it can receive a plurality of frozen desserts 32. The upper enclosed portion 30 further includes an electrical connector 35 which matingly connects to a portion of the container for permitting electrical signal transmission between the container and the docking station 10. Tabs 85a and 85b are disposed in the upper portion of container 32 for permitting easily removing frozen dessert container 32 without any tools. Two recessed portions 140 are also positioned on the upper portions of 30 for a securing fit warming vessel 70 and the control insert 50.

A transmit button 50 is disposed in the upper enclosing portion 30 permitting a user to initiate direct current (d.c.) by pressing the button 50. A light 60 is included on the upper enclosing portion 30 for indicating the plurality connector devices allowing the flow of current to Peltier thermoelectric cooling system. Such thermoelectric cooling systems are well-known in the art and will not be discussed in detail herein. A power cable 80 is also attached to the base portion 20 which power cable 80 is connected to the base portion 20 which power cable 80 is connected to an electrical outlet (not shown) for supplying electrical power to the docking station 10.

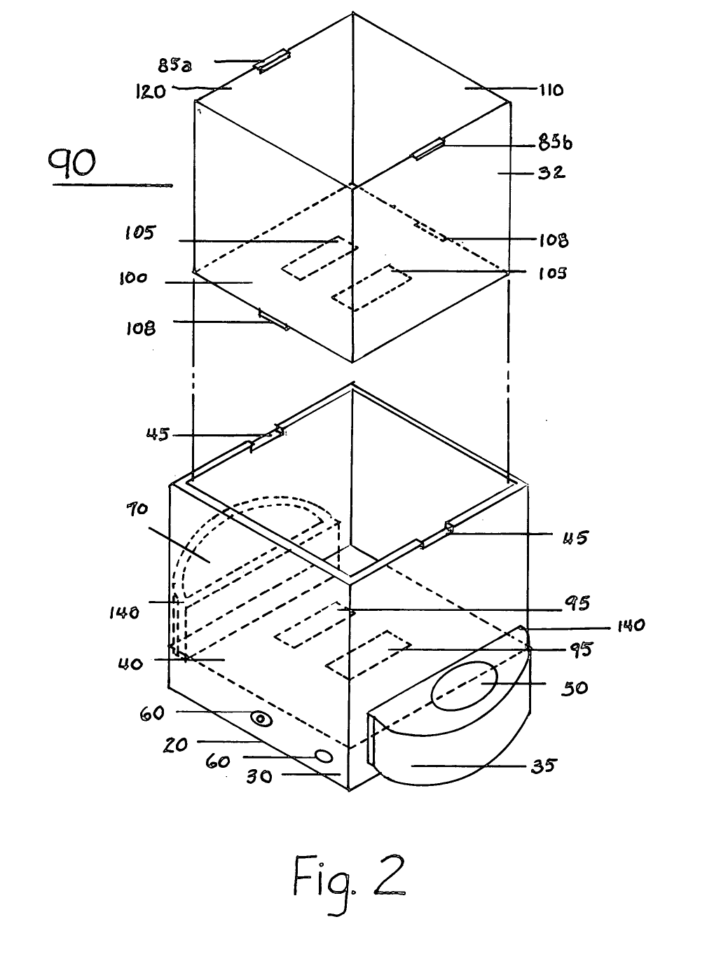

Referring to FIG. 2, there is shown the replaceable insert 90 of the present invention. The insert 90 includes a bottom portion 100 (not shown in it's entirely) having a shape that substantially conforms to the shape of the indentation 40 of the docking station 10 for permitting the insert 90 to be matingly received by the docking station 10. The insert 90 includes an upper portion 110 having contoured-shape portion 120 which conforms substantially to the shape of a mating portion of a frozen dessert indentation 40 to which it will be mated. It is instructive to note that the docking station 10 permits a plurality of inserts to be inserted therein all of which mate to the indentation portion 40. The base portion 30 further includes a conformal cooling plate 95 for permitting the electrical connection 35 of the docking station 10 in cooling association with at least a portion of one side of the container or object to be cooled. Two stabilizing elements 105 are disposed on the floor of the insert 90 for stabilizing the connection of the frozen dessert container 90 to the docking station 10. Positioning tabs 108 are disposed around the peripheral portion of the insert 90 for securing the fit of the insert 90 to the docking station 10. It is instructive to note that the tabs 85a and 85b respectfully mates with the docking station recesses 45. The embodiment shown in FIG. 2 is an example of one of the polarity of inserts.

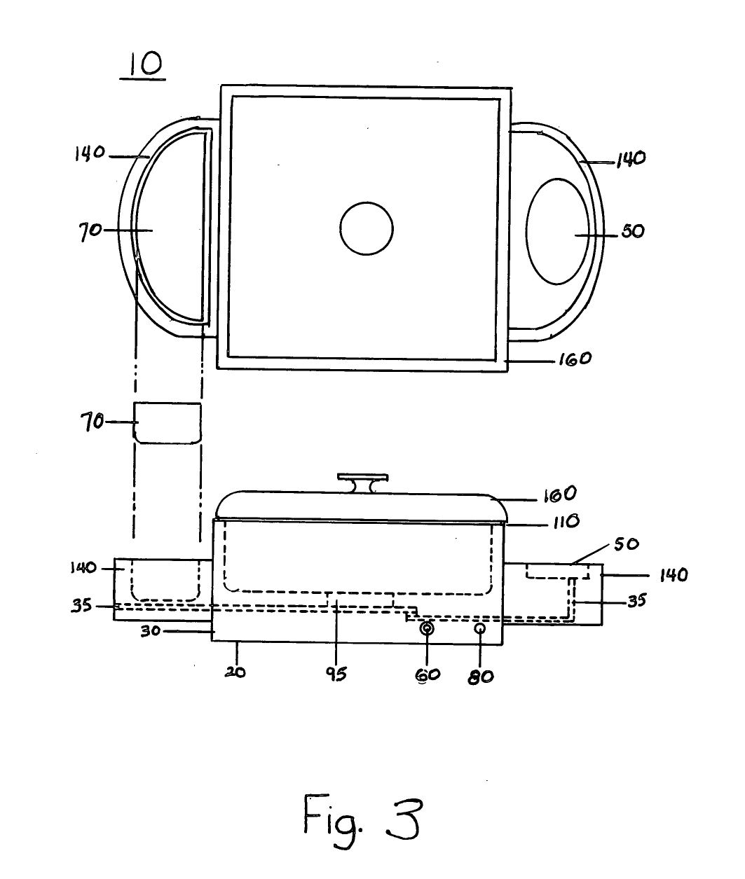

FIG. 3 illustrates another example of an insert 90 having the same components as discussed above. It is to be noted, however, that the contoured-shape portion 140 has a different shape from the previously discussed insert 90 permitting reception of a different container 70.

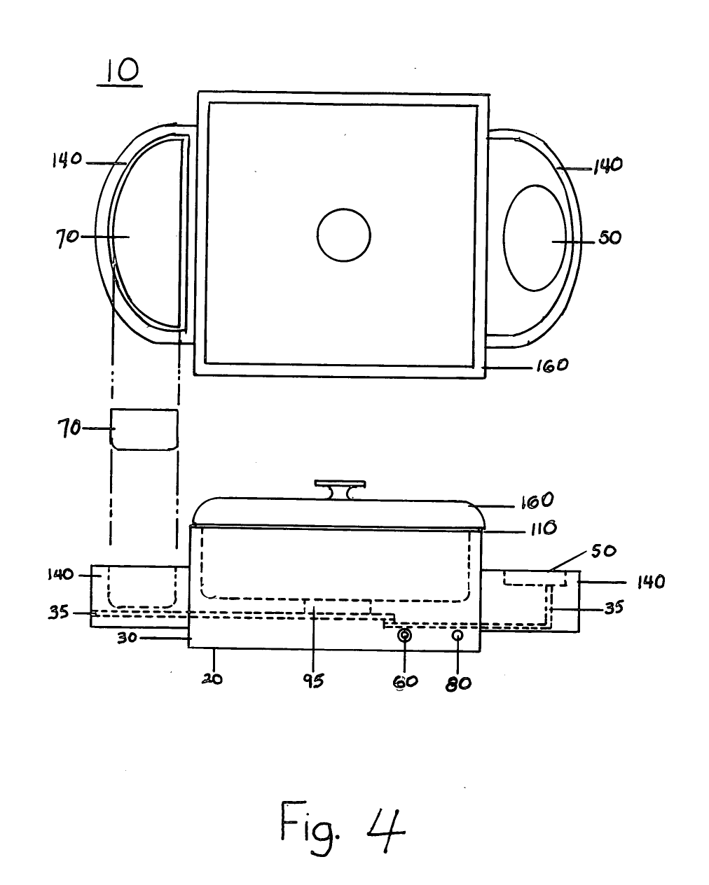

Referring to FIG. 4, and for clarity of understanding, there is shown the insert 50 matingly placed in the docking station 10. As is obvious from the illustration, the docking station 10 and the insert 50 mate together in an integrated manner with conformal cooling plate 95. The second embodiment shown in FIG. 4 is an example of one of the plurality of insert to the docking station 10. The indentation portion 140 permits an inserted warming vessel.

Referring to FIG. 5, it is instructive to note that the lid 160 shown is separated from docking station 10, having the contoured-shape of upper rim 110. The stabilizing elements secure the connecting insert around the peripheral portion for a securing fit of the lid 160 to the insert 90 and the docking station 10.

Although the preferred embodiment illustrates a frozen dessert container, it is instructive to note that frozen dessert devices in plastic, ceramics, metal, composite material, or paper may be installed for the container.

The invention has been described with reference to a preferred embodiment. However, it will be appreciated that variations and modifications can be effected by a person of ordinary skill in the art without departing from the scope of the invention.

### PARTS LIST

10 DOCKING STATION
20 BASE PORTION
30 UPPER ENCLOSED PORTION
32 FROZEN DESSERT CONTAINER
35 ELECTRICAL CONNECTOR
40 INDENTATION PORTION
45 RECESSED PORTION
50 TRANSMIT PORTION
60 LIGHT
70 WARMING VESSEL
80 POWER CABLE
85 TAB FINGER INSERT
90 REPLACABLE INSERT
95 CONFORMAL COOLING PLATE
100 BOTTOM PORTION
105 STABILIZING ELEMENTS
108 POSITIONING TABS
110 CONTOURED-SHAPE LID RIM
120 CONTOURED-SHAPE OF THE CONTAINER MATING PORTION
140 RECESSED INSERT PORTIONS
160 LID

What is claimed is:

1. A docking station assembly for maintaining frozen desserts, the docking station assembly comprising:
a) a housing for forming an enclosure for the docking station assembly and said housing includes an insert-receiving portion for receiving any of a plurality of removable and replaceable inserts; and
b) a removable and replaceable insert having a docking mating portion which mates with the insert-receiving portion, and having a thermoelectric cooling system portion having a shape of a portion of a particular Peltier effect electronic device.

2. The docking station assembly as in claim 1 further comprising a plurality of removable and replaceable inserts.

3. The docking station assembly as in claim 1, wherein the insert-receiving portion is a notched-out portion.

4. The docking station assembly as in claim 1, wherein the electronic device is a Peltier effect thermoelectric cooling electronic device.

5. The docking station assembly as in claim 1, wherein the electronic device is a heat exchanging device.

6. The docking station assembly as in claim 1 further comprising an electrical fan connection on the housing for connection to the electronic device.

7. The docking station assembly as in claim 6 further comprising a floor of the insert having a notched-out portion through which the electrical connection passes.

8. The docking station assembly as in claim 7 further comprising one or more stabilizing elements for providing stable support for connection of the electronic device to the insert.

9. The docking station assembly as in claim 2 further comprising placing an article of interest on a heat source with electrical cable attached to said housing for thermoelectrically cooling the article of interest.

10. The docking station assembly as in claim 9 further comprising a power cable attached to said housing for a thermoelectric module providing direct current to the docking station assembly.

11. The docking station assembly for cooling frozen desserts, the docking station assembly comprising:
a) a housing for forming an enclosure for the docking station assembly and said housing includes a notched-out portion for receiving any of a plurality of removable and replaceable inserts that mates both with the housing and a particular electronic device having an electric circuit providing d.c. power source, the control assembly, and the thermoelectric module being connected to each other in a series.

12. The docking station assembly as in claim 11 further comprising a removable and replaceable insert having a docking mating portion which mates with the notched-out portion, and having a frozen dessert container mating portion having a shape of a portion of a particular electronic device.

13. The docking station assembly as in claim 6 further comprising a housing for forming an enclosure for insert-receiving portion having a docking mating portion which mates with the fan device and a removable and replaceable insert having a docking mating portion which mates both a portion of a particular electronic device and the notched-out portion of the docking station assembly.
